(19) United States
(12) Patent Application Publication
(10) Pub. No.: US 2012/0242265 A1
(43) Pub. Date: Sep. 27, 2012

(54) Method for operating an electric machine, and drive device

(76) Inventors: Boyke Richter, Karlsruhe (DE); Torsten Heidrich, Vaihingen/Enz (DE)

(21) Appl. No.: 13/395,030

(22) PCT Filed: Jul. 21, 2010
(86) PCT No.: PCT/EP2010/060564

§ 371 Date: May 23, 2012

(30) Foreign Application Priority Data
Sep. 10, 2009 (DE) 10 2009 029 327.2

(51) Int. Cl. H02P 6/16

(52) U.S. Cl. 318/400.11; 318/400.37; 180/65.285; 903/906

(57) ABSTRACT

In a method for operating an electric machine of a drive device, which electric machine has a rotor and a stator, and which drive device has a drive unit, an angular position of the rotor with respect to the stator is determined on the basis of an angle-of-rotation encoder associated with the drive unit.

### BACKGROUND OF THE INVENTION

1. Field of the Invention

The present invention relates to a method for operating an electric machine of a drive device, the electric machine having a rotor and a stator and the drive device having a drive unit.

2. Description of Related Art

Methods of the type described at the outset are known from the related art. The electric machine is used for example in the form of a permanent-magnet synchronous machine or a three-phase asynchronous machine as a starter (crankshaft start generator) for the drive unit. The drive unit in this case may be an internal combustion engine of a motor vehicle. Such a starter is normally provided between the internal combustion engine and a transmission of the drive device. For operating the electric machine, both in the variant of the permanent-magnet synchronous machine as well as in that of the three-phase asynchronous machine, it is necessary to know the position or angular position of the rotor vis-à-vis the stator in order to produce a defined torque. A position sensor is provided in the electric machine for determining the angular position. Alternatively, the angular position may be ascertained without a sensor from the currents occurring in the electric machine and/or from phase voltages of the electric machine. At low rotational speeds of the electric machine such as when starting or running up the electric machine or the drive unit, however, the last-mentioned procedure, that is, the sensorless method, has the disadvantage of reducing the torque of the electric machine. For this reason, the electric machine typically has at least one sensor for determining the angular position. Such a sensor, however, requires a considerable installation space, even though the available space for integrating the electric machine between the internal combustion engine and a transmission of the drive device is limited. The sensor is also cost intensive.

### BRIEF SUMMARY OF THE INVENTION

By contrast, the method for operating the electric machine according to the present invention has the advantage that the determination of the angular position of the rotor with respect to the stator, which is required for operating the electric machine, may be performed without the electric machine for this purpose having to have the sensor for determining the angular position or without having to use the sensorless method while operating the electric machine at a setpoint speed. According to the present invention, this is achieved in that the angular position of the rotor with respect to the stator is determined on the basis of an encoder or sensor associated with the drive unit, in particular an angle-of-rotation encoder. The electric machine consequently does not require a sensor of its own. This makes it possible to construct the electric machine in markedly smaller dimensions. The costs for the sensor are also eliminated. The drive unit includes the associated rotational pulse encoder in any case. It is therefore practical to use the signals produced by the latter in order to determine the angular position of the rotor. For this purpose, the angle-of-rotation encoder normally produces at least one signal that is suitable for determining a relative angle. In this case it may be necessary to determine first the absolute angular position of the rotor with respect to the stator before a further operation of the electric machine may occur on the basis of the data provided by the angle-of-rotation encoder. Once the absolute angular position is known, it may be determined subsequently on the basis of the relative angle detected by the angle-of-rotation encoder.

In the event of a failure of the encoder, in particular the angle-of-rotation encoder, suitable alternative methods may be used to determine the angular position and thus to operate the electric machine. The angular position may also be determined in a sensorless manner for example. This sensorless determination is used especially in the event of a failure of the angle-of-rotation encoder, it being provided by evaluating voltages induced in the electric machine or by applying at least one current pulse on a winding of the electric machine. The term “sensorless” is to be interpreted in such a way that no sensor is provided on the electric machine for detecting the angular position or the relative angle. In a normal operation of the electric machine, voltages are induced in it, which may be analyzed by a control unit for example. It is possible to determine the (absolute) angular position of the rotor with respect to the stator from these induced voltages. Alternatively, the sensorless determination may also be performed in such a way that the at least one current pulse is applied on the winding of the drive unit, in particular of the stator of the drive unit. During such an application, no torque-producing current is supplied to the electric machine. Consequently, in order to determine the angular position of the rotor, the electric machine outputs no torque, at least for a brief period. Such a procedure thus results in the electric machine being operated at a reduced torque. In spite of the use of the angle-of-rotation encoder of the drive unit, which could possibly fail, the electric machine may thus be operated with a high degree of robustness since the electric machine may be operated in an emergency operating mode in the event of a failure of the angle-of-rotation encoder, in which case the angular position is determined in a sensorless manner.

A development of the present invention provides that for starting the electric machine, the angular position of the rotor with respect to the stator is initially determined by applying at least one current pulse on a winding of the electric machine and is subsequently determined by the relative angle detected with the aid of the rotational pulse encoder. In this instance, the electric machine is started preferably from a standstill of the electric machine, but always in a state in which no torque-producing current is supplied to the electric machine. Prior, during or after the start of the electric machine, the current pulse is applied on the winding, in particular of the stator, of the electric machine. Such a procedure is described in published German patent application document DE 102 21 385 A1. This procedure is used to determine initially the absolute angular position of the rotor. Subsequently, that is, after the start—when the electric machine has reached a sufficiently high rotational speed—the angular position is determined on the basis of the relative angle, which is determined by the angle-of-rotation encoder of the drive unit. The angular position then indicates an electrical angular position of the rotor. After the absolute angular position of the rotor has been determined by the application of the current pulse, the electric machine may be powered in a suitable manner so that it produces the desired torque, which is used for example for starting the drive unit.

The angle-of-rotation encoder of the drive unit is evaluated for determining the angular position further. In the process, the previously determined angular position is respectively corrected by the detected relative angle. Such a procedure has the advantage that by eliminating current pulses after the initial determination of the angular position, the electric machine is able to provide its maximum torque since it does not need to be operated at a lower torque, which would be necessary for a sensorless determination of the angular position. The above-described method is advantageously applied in such a way that the determination of the angular position using the current pulse occurs when the electric machine is at a standstill, while the relative angle is used to correct the angular position as soon as the electric machine provides a rotational speed greater than zero or a torque greater than zero. In the event of a failure of the angle-of-rotation encoder, it is possible to determine the angular position initially in the manner described using the current pulse, while subsequently—for higher rotational speeds of the electric machine—a different sensorless method may then be used to determine the angular position.

Such a method is for example the evaluation of the induced voltages of the electric machine, which may be a permanent-magnet synchronous machine, as described in published international patent application document WO 2002/052714 A1. This makes it possible to increase the robustness or the operational reliability of the electric machine. The determination of the angular position with the aid of the current pulse occurs very quickly since the position of the rotor is detected with an accuracy of half of an angular increment, which is 180°/m, already after a number m of current pulses or test current pulses in an m-phase or m-strand stator winding. Such an accuracy already suffices for starting the electric machine. In a three-phase or three-strand stator winding, a total of three current pulses are thus sufficient to be able to assign the angular position of the rotor to an angular sector of 60°. Once the angular position is determined, then the accuracy of the angular position may be increased with a, particularly a low, number of additional current pulses, and thus the possible torque of the electric machine may be increased further both at an active as well as at a passive load.

A development of the present invention provides for a plurality of current pulses to be applied consecutively to the electric machine in such a way that the current pulses produce stator flux vectors mutually offset by angular increments; that, in each applied current pulse, the phase currents in two winding phases that have current running through them in the same direction are measured and compared with each other and that a sector of 180° is determined for the angular position from the comparison, which, depending on in which winding phase the greater or lesser phase current is measured, follows upon the phase position of the stator flux vector toward greater or smaller angles; that the sector for the angular position is limited to the magnitude of an angular increment by an intersection of the determined 180° sectors; and that an angular position of the axis of symmetry of the intersection sector is defined as the rotor position. Once the angular position has been determined in accordance with the above explanations, a current pulse is applied to the electric machine or to its stator winding, which produces a torque-forming stator flux vector. The phase position of the stator flux vector is offset for example by 90° in a rotor direction of rotation selected as the direction of force with respect to the previously determined angular position of the rotor. Following a time span, which may be constant or may also be selected as a function of the rotational speed of the electric machine, at least one additional current pulse—preferably a small number of current pulses—is applied to the stator winding for checking the angular position of the rotor.

If the angular position has not changed with respect to the previously determined angular position, then the torque-forming stator flux vector is again produced by applying the current pulse. If this is followed by a rotation of the rotor, that is by a change of the angular position, then a current pulse is applied to the stator winding in such a way that a torque-forming stator flux vector is generated. Its phase position is in turn to be offset by 90° for example with respect to the newly determined angular position. This process is repeated until a sufficient rotational speed of the electric machine is obtained or detected. Subsequently, a switchover is performed to the determination of the angular position on the basis of the relative angle detected by the rotational pulse encoder. This eliminates the applied current pulses and the electric machine is utilizable with its full capability or its full torque. The current pulses may be applied in different ways. Preferably, semiconductor switches (for example MOSFETs connected in a two-way bridge circuit) are provided for this purpose.

If the direction of rotation of the electric machine is known, then another current pulse is applied in such a way that it produces a stator flux vector whose phase position is offset in the direction of force by half of an angular increment with respect to the determined angular position. The phase currents of the two winding phases that have current flowing through them in the same direction are in turn measured and compared to each other. A sector of 180° following the phase position of the generated stator flux vector is determined from the comparison for a new angular position, which runs ahead of or trails behind the stator flux vector, depending on in which winding position the greater (or lesser) phase current is measured. The new angular position is determined as the phase position of the stator flux vector offset in the direction of force by a half angular increment if the 180° sector runs ahead and as the phase position of the current flux vector offset by a half angular increment counter to the direction of force if the 180° trails behind. The application of the additional current pulse to the winding of the electric machine or to the stator winding for the production of torque is performed in such a way that the phase position of the torque-forming stator flux vector produced by the current pulse is offset electrically by 90° with respect to the newly determined rotor position in the direction of force.

If the direction of rotation is unknown by contrast, then the application of the at least one additional current pulse is performed in such a way that a first of the additional current pulses produces a first stator flux vector whose phase position is offset against the direction of force by half of an angular increment with respect to the previously determined angular position. The phase currents of the two winding phases that have current flowing through them in the same direction are in turn measured and compared to each other and a sector of 180° following the phase position of the generated stator flux vector is determined from the comparison for a new angular position, which runs ahead of or trails behind the stator flux vector in the direction of force, depending on in which winding position the greater (or lesser) phase current is measured.

In the case where the 180° sector is trailing behind, the new angular position is determined as the phase position of the generated current flux vector offset against the direction of force by one half of an angular increment and the application of the additional current pulse to the stator winding for producing the torque is performed in such a way that the phase position of the torque-forming stator flux vector generated by the current pulse is offset in the direction of force by 90° with respect to the new angular position. In the case where the 180° runs ahead, a second of the additional current pulses is applied to the winding, which produces a second stator flux vector offset by one angular increment with respect to the phase position of the first stator flux vector generated by the first of the additional current pulses. The phase currents of the two winding phases that have current flowing through them in the same direction are in turn measured and compared to each other and a sector of 180° following the phase position of the second stator flux vector generated by the second of the additional current pulses is determined from the comparison for a new angular position.

The new angular position is determined as the phase position of the second stator flux vector generated by the second of the additional current pulses and offset against the direction of force by one half of an angular increment if the 180° trails behind, and is determined as the phase position of the second stator flux vector generated by the second of the current pulses and offset in the direction of force by one half of an angular increment if the 180° sector runs ahead. The application of the additional current pulse on the winding for producing the torque is performed in such a way that the phase position of the torque-forming stator flux vector generated by the current pulse is offset in the direction of force by 90° with respect to the angular position.

A development of the present invention provides for the encoder or the angle-of-rotation encoder to detect an absolute angular position for at least one angular position and for this to be used to correct the angular position of the rotor. The angle-of-rotation encoder is thus developed in such a way that it is able to determine the absolute angular position in at least one angular position. This is the case, for example, if the angle-of-rotation encoder includes a pulse generator wheel. The latter has for example 60 angular increments or marks indicated by teeth. No teeth are provided at two of these angular positions. These two missing teeth of the pulse generator wheel, which thus has 60-2 teeth, may be used to determine the absolute angular position and thus also to correct the angular position of the rotor.

The present invention furthermore includes a drive device, in particular for implementing the method according to the above explanations, including an electric machine, the electric machine having a rotor and a stator and the drive device having a drive unit. A control device is provided, which, for the purpose of operating the electric machine, determines an angular position of the rotor with respect to the stator using an angle-of-rotation encoder associated with the drive unit. The control device may be developed in such a way for example that for starting the synchronous machine it first determines the angular position of the rotor with respect to the stator by applying at least one current pulse on a winding of the synchronous machine and subsequently determines it on the basis of a relative angle detected by the angle-of-rotation encoder or even in a sensorless manner. This procedure was already described above.

A development of the present invention provides for the drive unit to be an internal combustion engine. For this purpose, the electric machine acts as a starter of the internal combustion engine, that is, it is designed as a crankshaft start generator for example, which acts both as a starter and as a generator.

One development of the present invention provides that the angle-of-rotation encoder be a pulse-generator wheel having an associated pick-up. The pulse-generator wheel is associated with the drive unit and is designed to output signals that signal respectively that a certain angular increment has been passed. The pulse-generator wheel may be subdivided into sixty angular positions for example, these angular positions being indicated by teeth that may be detected by a suitable device, e.g. a sensor. No teeth are provided at two of the angular positions. Thus, when the absence of the teeth is detected, then the rotational pulse encoder or the pulse-generator wheel is capable of detecting not only a relative angle, but an absolute angular position. The latter may be used to correct the angular position of the electric machine.

### BRIEF DESCRIPTION OF THE DRAWING

FIG. 1 shows a schematic representation of a drive device.

### DETAILED DESCRIPTION OF THE INVENTION

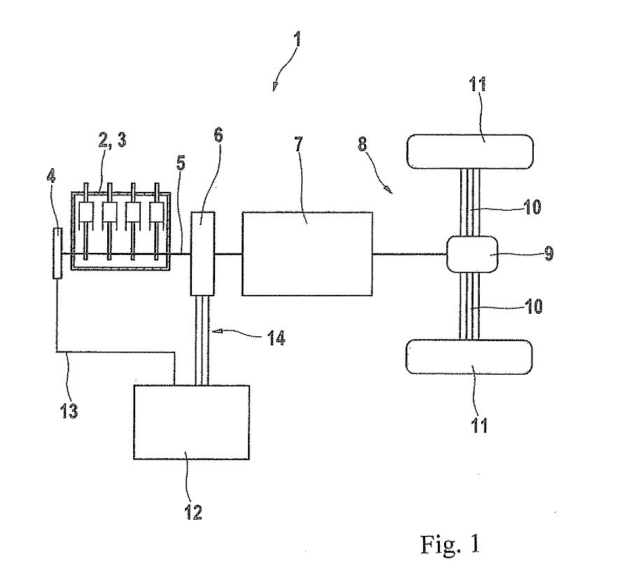

The FIG. 1 shows a schematic representation of a drive device 1, which is associated with a motor vehicle (not shown) for example. Drive device 1 has a drive unit 2, which is developed as an internal combustion engine 3. Internal combustion engine 3 has an encoder, in particular an angle-of-rotation encoder 4, which is developed as a pulse-generator wheel, in particular having an associated pick-up or sensor. Angle-of-rotation encoder 4 is coupled to internal combustion engine 3 in such a way that in an operation of internal combustion engine 3 it is possible to determine a rotation of a crankshaft drive 5 of internal combustion engine 3. The rotational speed of the pulse-generator wheel may be ascertained from the output signal of the angle-of-rotation encoder in a known manner. Therefore, angle-of-rotation encoder 4 may also be called a rotational speed sensor.

An electric machine 6, which cooperates with internal combustion engine 3, is also provided in drive device 1. It is used as a starter-generator, in particular as a crankshaft start generator, which may be operated both as a starter and as a generator. Like angle-of-rotation encoder 4, electric machine 6 is also coupled to crankshaft drive 5 of internal combustion engine 3. A gear unit 7, which may also include a starting clutch for example, is also coupled to crankshaft drive 5. A drive train 8 of the motor vehicle is connected subsequent to gear unit 7, drive train 8 having a differential 9, via which axles 10 of the motor vehicle are connected to its wheels 11.

Drive device 1 additionally has a control unit 12. It is used to control electric machine 6, but may also assume additional tasks such as controlling internal combustion engine 3 for example. Control unit 12 is connected to angle-of-rotation encoder 4 such that signals output by the angle-of-rotation encoder are transmitted to control unit 12. A line 13 is provided for this purpose. The signals are output by angle-of-rotation encoder 4 when a rotation of the crankshaft drive by a specific angle of rotation is established. Thus, angle-of-rotation encoder 4 is used to determine relative angles of crankshaft drive 5. Control unit 12 is connected to electric machine 6 via a three-phase connector 14. A current pulse may be applied to at least one winding of electric machine 6 via each of the three phases of connector 14.

When operating drive device 1 or electric machine 6, it is also possible to detect a relative angle of a rotation of electric machine 6 due to the coupling of rotational pulse encoder 4, internal combustion engine 3 and electric machine 6 via crankshaft drive 5. Since it is necessary to know the angular position of a rotor with respect to a stator of electric machine 6 in order to be able to operate it, the signal of rotational pulse encoder 4 is used to determine this angular position. It is thus not necessary to provide a separate sensor on electric machine 6 for determining the angular position of the rotor with respect to the stator. It is thus possible to construct electric machine 6 in smaller dimensions and in a more cost-effective manner.

1-7. (canceled)

8. A method for operating an electric machine of a drive device, wherein the electric machine has a rotor and a stator, and wherein the drive device has a drive unit, the method comprising:
determining an angular position of the rotor with respect to the stator based on an output of an angle-of-rotation encoder associated with the drive unit; and
controlling the operation of the electric machine based on the determined angular position.

9. The method as recited in claim 8, wherein for starting the electric machine, at least one current pulse is applied on a winding of the electric machine and the angular position of the rotor with respect to the stator is determined based on the output of the angle-of-rotation encoder.

10. The method as recited in claim 8, wherein multiple current pulses are applied consecutively on the electric machine in such a way that:
the current pulses produce stator flux vectors mutually offset by angular increments;
in each applied current pulse, phase currents in two winding phases having running current in the same direction are measured and compared with each other;
a first sector of 180° is determined for the angular position based on the comparison of the phase currents, wherein the first sector of 180°, depending on in which winding phase one of the greater or lesser phase current is measured, follows upon the phase position of the stator flux vector toward one of greater or smaller angles;
a sector for the angular position is limited to the magnitude of an angular increment by an intersection sector of the first sector of 180° and a second sector of 180°; and
an angular position of the axis of symmetry of the intersection sector is defined as the rotor position.

11. The method as recited in claim 8, further comprising:
detecting, by the angle-of-rotation encoder, at least one absolute angular position; and
correcting the angular position of the rotor with respect to the stator based on the detected absolute angular position.

12. A drive device for a vehicle, comprising:
a drive unit;
an electric machine having a rotor and a stator;
an angle-of-rotation encoder associated with the drive unit; and
a control device configured to determine, for operating the electric machine, an angular position of the rotor with respect to the stator based on an output of the angle-of-rotation encoder.

13. The drive device as recited in claim 12, wherein the drive unit is an internal combustion engine.

14. The drive device as recited in claim 13, wherein the angle-of-rotation encoder is a pulse-generator wheel.
